(19) United States
(12) Patent Application Publication
(10) Pub. No.: US 2002/0178107 A1
(43) Pub. Date: Nov. 28, 2002

(54) Method and processing system for distributing purchased goods at retail or wholesale outlet stores

(76) Inventor: Perry Biancavilla, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/863,683

(22) Filed: May 22, 2001

(51) Int. Cl. G06F 17/60

(52) U.S. Cl. 705/37

(57) ABSTRACT

A method and processing system for distributing purchased goods at retail or wholesale outlet stores according to an agreement between a manufacturer of the goods and a retail or wholesale outlet store. In a preferred embodiment, the agreement provides that the retail or wholesale outlet store receive the goods in bulk packaging, warehouse the goods, and package the goods in intimate level protection packaging when the purchaser provides order confirmation information (e.g., a pickup number) acquired via a Website that the purchaser utilized to purchase the product “on line” for in-store pick-up at that particular retail or wholesale outlet store. When this information is provided to the store, an exemplary preferred processing system automatically provides the store with a packing list to assist in the packaging operation and initiates a transfer of funds to an account designated by the store.

### BACKGROUND OF THE INVENTION

1. Field of Invention

The present invention relates generally to a method and processing system for distributing purchased goods at retail or wholesale outlet stores and, more specifically, to a method and processing system for distributing purchased goods at retail or wholesale outlet stores according to a contractual relationship (between a manufacturer of the goods and a retail or wholesale outlet store) which provides that the retail or wholesale outlet store receive the goods in bulk packaging, warehouse the goods and package the goods in intimate level protection packaging when a purchaser of the goods provides order confirmation information (e.g., a pick-up number) acquired via a Website that the purchaser utilized to purchase the product “on line” for in-store pick-up at that particular retail or wholesale outlet store.

2. Description of the Related Art

For consumers, shopping over the Internet is convenient but the cost of shipping the purchased goods often drives up the total price of the transaction. In addition to shipping costs, it is often difficult to coordinate a personal or work schedule to be at the shipping address at the right time to receive items that must be signed for. Missed deliveries sometimes result in additional inconveniences such as having to make a special trip to the post office to pick up a package. For a purchaser who wants or needs to receive an item as soon as possible, it would be desirable to be able to check a local store via a Website to determine whether that item is available and currently in stock and, if yes, reserve and/or purchase the item and then drive over to the local store to pick it up. In addition to receiving the item that day, the purchaser would also save on shipping costs and avoid wasting time driving to the store only to discover that the item is not in stock.

For retailers and wholesalers, the proliferation of “on-line” shopping is making the task of luring shoppers into their traditional “brick and mortar” stores ever more difficult. It would be helpful to such retailers and wholesalers if they could devise a way to increase “foot traffic” through their stores and, in particular, motivate Internet shoppers to leave their houses and actually go to the “brick and mortar” store.

For manufacturers of goods, the costs associated with warehousing goods, packaging goods and shipping goods all decrease net revenues. As product managers continue to prodigiously increase the variety of products available for consumers to choose from, finding enough warehouse space is becoming an even greater challenge for manufacturers. Clearly it would help a manufacturer's profitability to be able to manufacture its goods and then promptly ship them somewhere else, thereby substantially or completely eliminating the need for the manufacturer to be concerned with warehousing the goods.

With e-commerce, packaging costs are often higher because fragile goods need to be packaged (and sometimes even require additional packaging beyond the standard “distribution packaging”) to withstand the rigors of shipping. Although manufacturers undoubtedly desire a way to reduce packaging costs, it is still necessary that a great percentage of the goods arrive at their shipping destination in undamaged condition. Otherwise, the number of returns increases, costs increase, and customer satisfaction decreases.

Although shipping costs are often passed on to the consumer, they can still cause a manufacturer to be less competitive in the marketplace. Sometimes the high cost of shipping dissuades a person from completing a telephone or on-line purchase that he or she otherwise would have made. Thus, it would not only be helpful to manufacturers to decrease shipping costs from the factory, but also to decrease (or eliminate entirely) shipping costs charged to the end purchaser.

### SUMMARY OF THE INVENTION

The method and processing system for distributing purchased goods at retail or wholesale outlet stores of the present invention generally pertain to the integration of an order processing system with various steps of a warehousing and packaging operation. In a preferred embodiment, the order processing system is a Website that allows Internet shoppers to identify retail or wholesale outlet stores near a particular geographic location, check to see whether desired goods are available and in stock at the identified stores, and purchase these goods “on line” for in-store pick-up at one of the stores. Upon completion of the “on line” purchase, the processing system provides the purchaser with order confirmation information (e.g., a pick-up number) which the purchaser, in turn, provides to the particular store where the goods are to be picked up.

The warehousing and packaging operation generally involves an agreement by one or more retail or wholesale outlet stores to warehouse goods for a manufacturer and to package the goods when a purchaser of the goods provides the order confirmation information. In a preferred embodiment, the agreement provides that the retail or wholesale outlet store receive the goods in bulk packaging, warehouse the goods, and package the goods in intimate level protection packaging when the purchaser provides the order confirmation information. When this information is provided to the store, an exemplary preferred processing system of the present invention automatically provides the store with a packing list to assist in the packaging operation and initiates a transfer of funds to an account designated by the contracting store.

In accordance with one embodiment of the present invention, a method for distributing purchased goods at retail or wholesale outlet stores includes the steps of: entering into one or more agreements with one or more retail and/or wholesale outlet stores to store and distribute goods that are different from displayed goods at the retail and/or wholesale outlet stores; and providing a mechanism (e.g., a Website) for customers to remotely order the goods stored at the one or more retail and/or wholesale outlet stores and receive order confirmation information; wherein the one or more agreements provide that, upon presentation of the order confirmation information at a retail and/or wholesale outlet store associated with the order confirmation information, possession of goods associated with the order confirmation information is transferred to a presenter of the order confirmation information.

In a preferred embodiment, the step of entering into one or more agreements is preceded by the step of: soliciting competing bids from prospective retail or wholesale outlet stores to provide the storage and distribution services. In a preferred embodiment, at least one of the agreements provides one or more of the retail and/or wholesale outlet stores an exclusive territory with respect to distribution of the goods.

In a preferred embodiment, the one or more agreements additionally require the retail or wholesale outlet stores to receive the goods in bulk containers and to package goods associated with the order confirmation information after the order confirmation information is presented to the retail or wholesale outlet stores. In a preferred embodiment, the packaging service involves providing the purchased goods with special intimate level protection packaging which eliminates the need for standard “distribution packaging”. In a preferred embodiment, the one or more agreements additionally require the retail or wholesale outlet stores to return the bulk containers once the bulk containers are empty.

In a preferred embodiment, the method additionally includes the step of electronically providing a retail or wholesale outlet store associated with the order confirmation information with a packing list associated with the order confirmation information after the order confirmation information is presented to the retail or wholesale outlet store. In a preferred embodiment, the method additionally includes the step of electronically transferring funds to a retail or wholesale outlet store associated with the order confirmation information after the order confirmation information is presented to the retail or wholesale outlet store.

In accordance with another embodiment of the present invention, a method for distributing purchased goods at retail or wholesale outlet stores includes the steps of: receiving order pick-up information from a customer; electronically transferring the order pick-up information to a remote order processing facility and electronically receiving a packing list associated with the order pick-up information; and pulling goods identified in the packing list from bulk containers and providing the goods to the customer without distribution packaging. In a preferred embodiment, the method further includes the step of packaging the goods in intimate level protection packaging before providing the goods to the customer. In a preferred embodiment, the method further includes the step(s) of packaging the goods in one or more structurally reinforced bags and/or packaging the goods in one or more bags with handles.

In accordance with another embodiment of the present invention, a processing system for distributing purchased goods at retail or wholesale outlet stores includes a processor configured to receive an inventory verification request and information pertaining to a geographic location, to identify one or more retail or wholesale outlet stores that are within a particular distance of the geographic location and that have in stock goods identified in the inventory verification request, and to generate a list of the one or more retail or wholesale outlet stores. In a preferred embodiment, the processor is further configured to generate order confirmation information associated with the goods identified in the inventory verification request and with one of the retail or wholesale outlet stores on the list, for example, with the retail or wholesale outlet store on the list that is closest to the geographic location and/or that is selected by a purchaser of the goods.

The above described and many other features and attendant advantages of the present invention will become apparent as the invention becomes better understood by reference to the following detailed description when considered in conjunction with the accompanying drawings.

### BRIEF DESCRIPTION OF THE DRAWINGS

Detailed description of preferred embodiments of the invention will be made with reference to the accompanying drawings:

FIG. 1 is a diagram illustrating the flow of information in an exemplary method and processing system for distributing purchased goods at retail or wholesale outlet stores according to the present invention;

FIG. 2 is a diagram illustrating operations performed at a retail outlet store according to an exemplary embodiment of the present invention; and

FIG. 3 is a flowchart illustrating steps of an exemplary method for distributing purchased goods at retail or wholesale outlet stores according to the present invention.

### DETAILED DESCRIPTION OF THE PREFERRED EMBODIMENTS

The following is a detailed description of the best presently known mode of carrying out the invention. This description is not to be taken in a limiting sense, but is made merely for the purpose of illustrating the general principles of the invention.

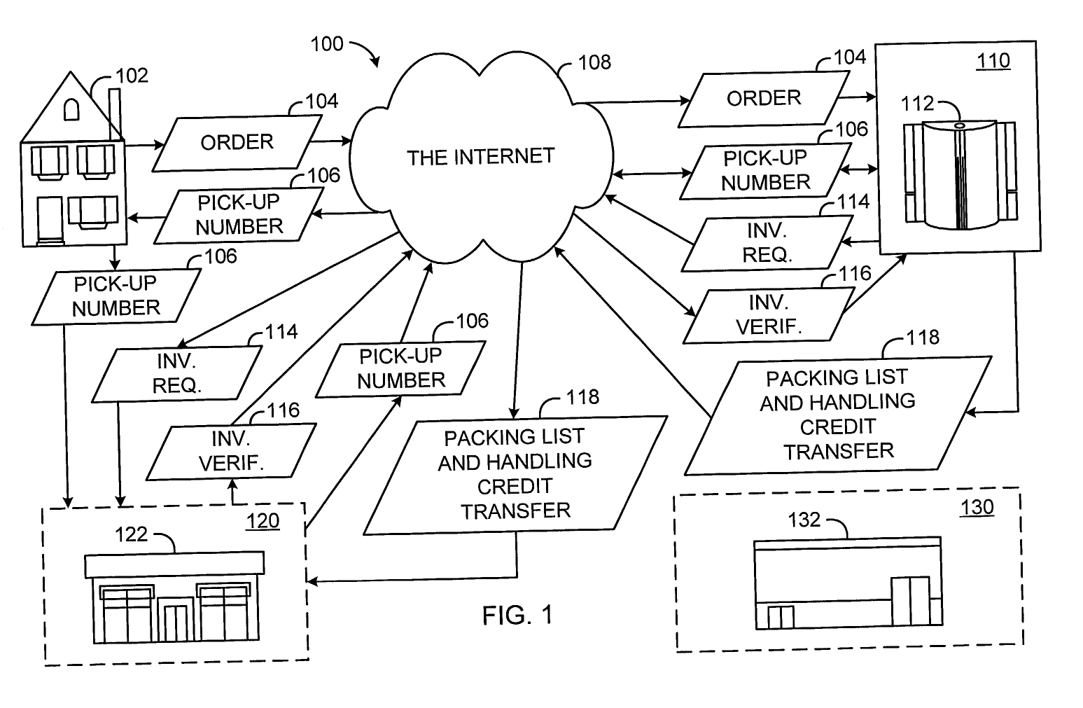

Referring to FIG. 1, a communication and goods distribution system 100 according to the present invention generally includes a node 102, a communication network 108, a processing mechanism 110 and a plurality of retail and wholesale outlet stores 122, 132. The communication node 102 can be any place or facility through which a customer can gain access to the communication network 108. For example, the communication node 102 can be facilitated via the home or office personal computer (PC) of a customer, provided the PC is equipped with the appropriate network interface hardware and/or software to enable communications between the PC and the communication network 108. However, it should be appreciated that the location of the communication node 102 is not limited to the residence or workplace of the customer. The communication node 102 can also be facilitated via a personal digital assistant (PDA) or other computing device. Moreover, computing devices other than those owned by the customer can be employed. For example, a computer leased at a cyber cafe is suitable as the communication node 102. Alternatively, the communications node 102 can be an authorized reseller of the manufacturer who communicates with the processing mechanism 110 through the communication network 108 or otherwise. While an exemplary preferred communication network 108 is the Internet, any communications network (public or private) can be employed.

The processing mechanism 110 is, for example, an order processing center operated by or on behalf of a manufacturer of goods. In the illustrated embodiment, a processor 112 is configured and/or programmed to control the processing system of the present invention. The general flow of information (data) according to the present invention is now discussed.

In a preferred embodiment, a customer connects (via the communications node 102 and the communication network 108) to a Website in order to shop “on line”. The Website is typically, but not necessarily, the Website of a manufacturer of goods. Generally, the Website is developed and maintained such that it provides the “on line” customer with an interactive interface through which goods can be viewed and purchased. More specifically, the Website is controlled by the processor 112 to allow the customer to purchase particular goods, products, items, etc. (“goods”) that are advertised on the Website and that are (or can be made) available for pick-up at a particular “brick and mortar” store. The term “brick and mortar” store means any store where goods are physically present and includes, but is not limited to, retail and wholesale outlet stores.

Inventories of goods sold through the Website are provided to particular stores (as discussed below in greater detail). The Website is controlled to remotely monitor these inventories of goods. For example, one or more databases of inventory data is/are made accessible to the processing system via the communication network 108 or otherwise.

In a preferred embodiment, the Website is controlled to allow the customer to request a list of retail or wholesale outlet stores that have particular goods available and in stock and that are within a particular distance (e.g., 5 miles, 10 miles, 20 miles, etc.) of a particular geographic location. For example, the Website can be constructed such that input information pertaining to a city, street address, zip code, etc. is used by the processor 112 to establish the geographic location. Thus, the location designated by the customer is not limited to where the customer is geographically. The ability to designate different locations allows the customer to make an “on-line” purchase for pick-up at any store for which inventory data is accessible by the processing system of the present invention.

In response to a customer's request for a list of local stores where he or she can pick up a particular product, the processing system controls the transmission of inventory requests 114 (as illustrated in FIG. 1) to the appropriate retail and wholesale outlet stores 122, 132. In response to the inventory requests 114, inventory verifications 116 are transmitted back to the processing facility 110. It should be appreciated, however, that the inventory database(s) is(are) not necessarily physically located at the retail and wholesale outlet stores 122, 132. Knowledge of the inventories of goods that are currently available at the stores and sold through the Website along with knowledge of the locations of these stores allows the aforementioned list to be generated and provided to the customer.

After the Website has been employed to select goods and a store location for pick-up of the goods, an order 104 is transmitted from the communications node 102 to the processing facility 110 as shown. After the purchase transaction is completed, e.g., with the customer's credit card, order confirmation information 106 (including, for example, a pick-up number) is transmitted back to the customer.

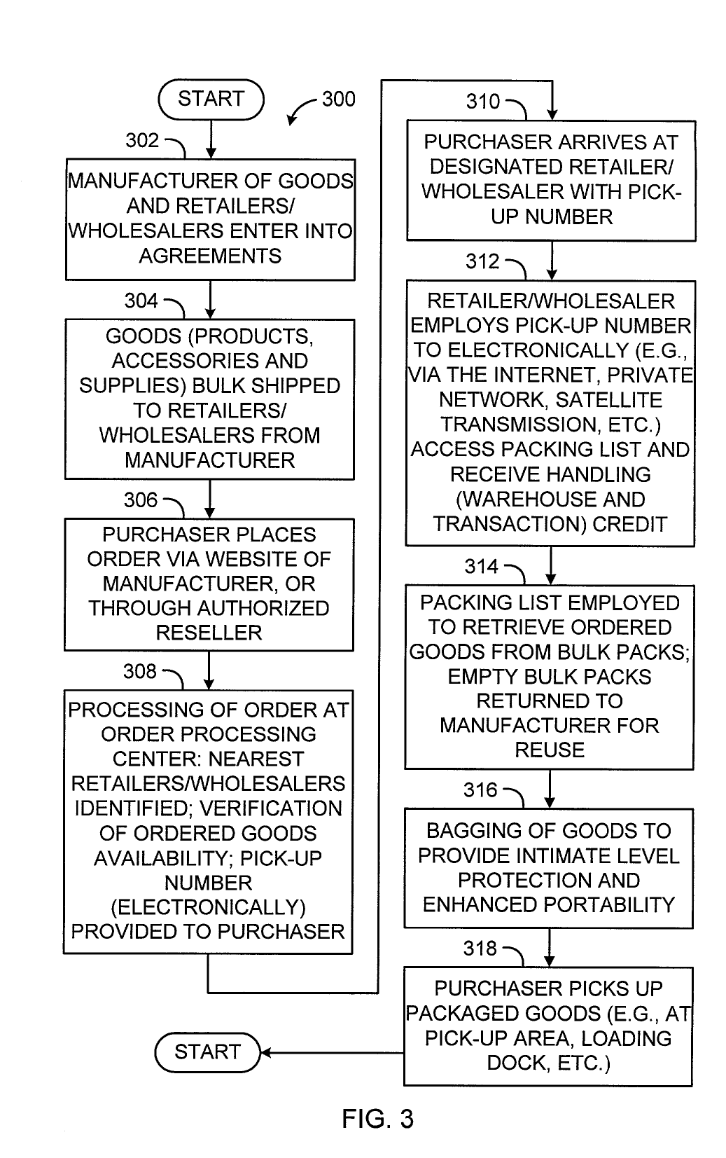

Referring to FIG. 3, an exemplary method 300 for distributing purchased goods at retail or wholesale outlet stores according to the present invention is shown in the form of a flowchart. At step 302, a manufacturer of goods enters into one or more agreements with one or more retail and/or wholesale outlet stores to provide various services including, but not limited to, storing and distributing goods. According to a preferred method, the goods stored and distributed by the retail and/or wholesale outlet stores are goods that can be viewed and purchased “on-line” via the Website of the manufacturer. According to a preferred method, the goods stored and distributed by a particular retail and/or wholesale outlet store are different from the goods on display at that particular retail and/or wholesale outlet store.

One or more of the agreements can provide a retail or wholesale outlet store with an “exclusive” territory with respect to storing and providing facilities for in-store pickup distribution of particular goods. Independent of whether an exclusive territory is involved, a preferred method according to the present invention also includes the step of soliciting competing bids from prospective retail or wholesale outlet stores to provide the various services. For example (and referring to FIG. 1), the retailer 122 can submit a bid and be awarded a territory 120 which can be exclusive or non-exclusive depending upon the terms of the agreement. Similarly, a wholesaler 132 can submit a bid and be awarded a territory 130 which can be exclusive or non-exclusive depending upon the terms of the agreement. As a result, both the manufacturer and the retail and wholesale outlet stores potentially benefit—the manufacturer by being able to select the most qualified retail or wholesale outlet stores, obtain more favorable contract terms, etc. and the retail and wholesale outlet stores by being provided with an additional revenue stream and, in some circumstances, obtaining an exclusive territory for the services that they have agreed to provide.

According to the method of the present invention, one or more of the agreements can require a retail or wholesale outlet store to receive the goods in bulk containers or “bulk packs”. Referring to FIG. 3, at step 304 the goods are bulk shipped to the retailers and wholesalers directly from the manufacturer (or from an interim warehousing facility). Conventional bulk bins, e.g., pallet-sized, are suitable for bulk shipping the goods. Preferably, the bulk containers are recyclable and/or returnable and reusable.

The manufacturer benefits from bulk shipping its goods because this eliminates the need to provide the shipped goods with distribution packaging and potentially decreases shipping costs as higher product densities (and therefore space savings) are achieved with bulk containers. Moreover, the manufacturer also saves by not having to warehouse the goods after they have been shipped to the retail or wholesale outlet stores.

At step 306, a purchaser submits an order for goods employing the Website of the manufacturer or through an authorized reseller of the manufacturer. As used here, the term “order” includes an inquiry regarding the availability of a particular good for in-store pick-up at retail and wholesale outlet stores that have entered into agreements with the manufacturer to provide the aforementioned various services.

At step 308, the order is processed as discussed previously and the order confirmation information is electronically provided to the purchaser. The Website of the manufacturer can be configured in a variety of different ways to strike an appropriate balance (which can be adjusted) between providing purchasers with great flexibility in designating order fulfillment options versus the costs of providing such an interactive interface and the potential for creating customer confusion. For example, in one embodiment of the present invention the order confirmation information is associated with the retail or wholesale outlet store that is selected by a purchaser of the goods. In another embodiment, the order confirmation information is associated with the retail or wholesale outlet store that is closest to a particular geographic location. In presenting options to the purchaser, the processing system can take into consideration still other criteria and, for example, can employ a prioritization scheme to assign different priorities to different retail and wholesale outlet stores depending upon a variety of factors such the competitiveness of pricing for the agreed upon services, inventory levels, prior performance ratings, etc.

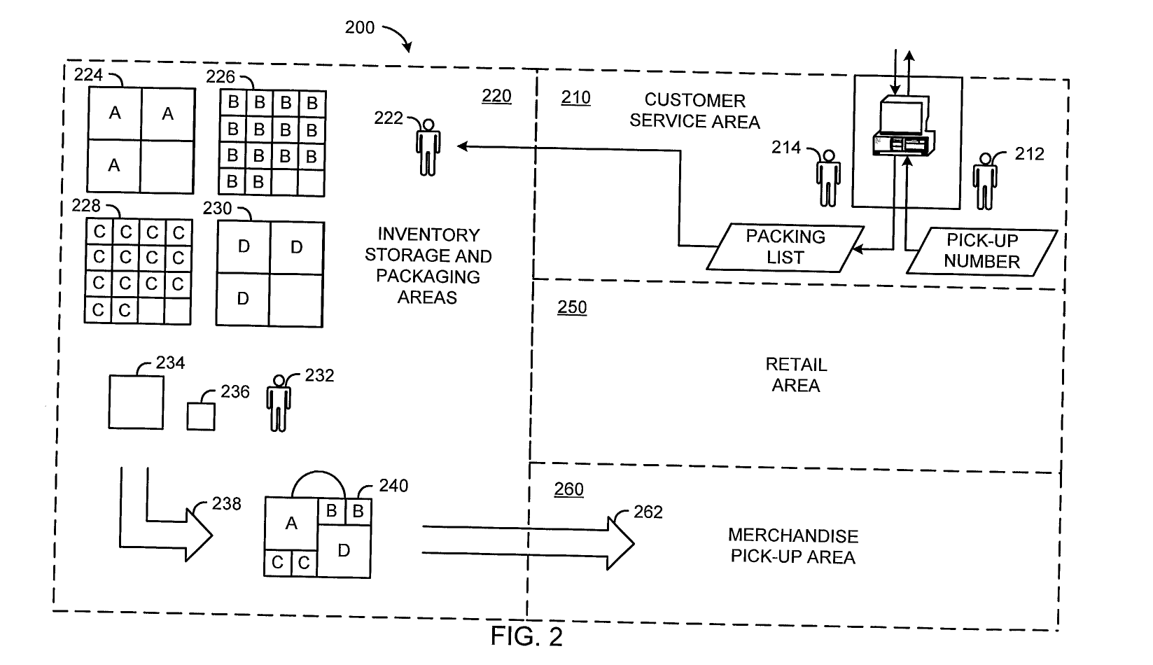

The following discussion also makes reference to FIG. 2 which shows an exemplary retail outlet store 200 with a customer service area 210, inventory storage and packaging areas 220, a retail area 250 and a merchandise pick-up area 260. At step 310, the purchaser provides his or her order confirmation information (e.g., pick-up number) to the retail or wholesale outlet store designated during the “on-line” purchase transaction. In a preferred embodiment, the purchaser (or a person in rightful possession of the order confirmation information) is required to deliver the order confirmation information in person at the store where the purchased goods are to be picked up. Alternatively, the order confirmation information can be remotely communicated to the retail or wholesale outlet store along with an indication of when the purchaser plans to arrive to pick up the purchased goods. According to an exemplary method of the present invention, the one or more agreements can also provide that, upon presentation of the order confirmation information at a retail and/or wholesale outlet store associated with the order confirmation information, possession of goods associated with the order confirmation information is transferred to a presenter of the order confirmation information.

By way of example (and referring to FIG. 2), a purchaser 212 arrives at the retail outlet store 200 and gives his pick-up number to a customer service representative 214 in the customer service area 210. The purchaser 212 is now free to roam about the retail area 250 or proceed directly to the merchandise pick-up area 260. It will probably take at least a few minutes for the purchased goods to be retrieved from the inventory storage and packaging areas 220. Therefore, some purchasers will prefer to shop in the retail area 250 rather than wait in the merchandise pick-up area 260. Preferably, the customer service area 210, the retail area 250 and the merchandise pick-up area 260 are arranged such that purchasers must pass through the retail area 250 on their way to the merchandise pick-up area 260 which could result in additional sales for the retailer or wholesaler. Even without such an arrangement, the retail and wholesale outlet stores potentially benefit by the fact that people who might not have otherwise visited these stores are physically present and thus might be susceptible to impulse buying, or simply decided that it makes sense to shop for something else while they are waiting.

At step 312, the customer service representative 214 transmits the order confirmation information (e.g., pick-up number) to the processing facility. Referring to the example shown in FIG. 1, the processor 112 receives the pick-up number 106 and generates a packing list and handling credit transfer 118 which is transmitted back to the retail store 122 via the Internet 108. Referring to FIG. 2, the packing list is forwarded electronically or otherwise to a storage area employee 222 in the inventory storage and packaging areas 220.

In one embodiment of the present invention, the processing system is configured to provide a packing list associated with the goods identified in the inventory verification request in response to an indication that the order confirmation information has been provided to the retail or wholesale outlet store associated with the order confirmation information. In another embodiment, the processing system is configured to initiate a transfer of funds in response to an indication that the order confirmation information has been provided to the retail or wholesale outlet store associated with the order confirmation information. Alternatively, the funds can be transferred as soon as the order confirmation information has been created or provided to the purchaser.

The method of the present invention also provides an e-commerce packaging solution. At step 314, the purchased goods are retrieved from a storage area under control of the retailer or wholesaler. By way of example, and referring to FIG. 2, the storage area employee 222 pulls goods identified in the packing list from bulk containers 224, 226, 228 and 230. The purchased goods in this example are denoted as A, B, B, C, C and D. According to a preferred method of the present invention, one or more of the agreements additionally require the retail or wholesale outlet stores to return the bulk containers once the bulk containers are empty, potentially providing additional savings to the manufacturer who can reuse the containers.

Further with respect to packaging, the purchased goods are preferably provided to the purchaser without distribution packaging. At step 316, the goods are provided with alternative packaging, i.e., intimate level protection packaging such as inexpensive plastic bags designed to provide the purchased products with a sufficient amount of protection to withstand the rigors typically associated with the goods being carried out of the store, placed in the trunk of a car (e.g., by a reasonably careful adult), and then driven to the purchaser's residence and unloaded. In most instances, this level of protection is less than that required to withstand the abuses of standard shipping.

By way of example (and referring to FIG. 2), the purchased goods (A, B, B, C, C and D) are packaged in bags 234, 236 by a packaging employee 232 who then carries the goods as indicated by arrow 238 to another area where the goods are placed into a carrying bag 240. Preferably the bags 234, 236 and the carrying bags 240 are designed in consideration of the particular goods being transported, i.e., structurally reinforced as necessary, provided with appropriate handles, etc. Moreover, the performance of these bags can be increased to provide more functionality in support of the customer pick operation, ergonomically designed features to enhance handling (putting goods into or taking goods out of the bags). The bags can also be printed, labeled, etc. with marketing, safety or other information. And finally, the goods are moved as indicated by arrow 262 to the merchandise pick-up area 260 where they are picked-up by the purchaser according to step 318 of the present invention.

In a preferred method, the one or more agreements require the retail or wholesale outlet stores to package goods associated with the order confirmation information after the order confirmation information is presented to the retail or wholesale outlet stores. Alternatively, the goods can be partially or completely packaged prior to receipt of the order confirmation information.

Although the present invention has been described in terms of the preferred embodiment above, numerous modifications and/or additions to the above-described preferred embodiment would be readily apparent to one skilled in the art. It is intended that the scope of the present invention extends to all such modifications and/or additions.

I claim:

1. A method for distributing purchased goods at retail or wholesale outlet stores, comprising the steps of:
entering into one or more agreements with one or more retail and/or wholesale outlet stores to store and distribute goods that are different from displayed goods at the retail and/or wholesale outlet stores; and
providing a mechanism for customers to remotely order the goods stored at the one or more retail and/or wholesale outlet stores and receive order confirmation information;
wherein the one or more agreements provide that, upon presentation of the order confirmation information at a retail and/or wholesale outlet store associated with the order confirmation information, possession of goods associated with the order confirmation information is transferred to a presenter of the order confirmation information.

2. The method for distributing purchased goods at retail or wholesale outlet stores of claim 1, wherein at least one of the agreements provides one or more of the retail and/or wholesale outlet stores an exclusive territory with respect to distribution of the goods.

3. The method for distributing purchased goods at retail or wholesale outlet stores of claim 1, wherein the step of entering into one or more agreements is preceded by the step of:
soliciting competing bids from prospective retail or wholesale outlet stores to provide storage and distribution services.

4. The method for distributing purchased goods at retail or wholesale outlet stores of claim 1, wherein the mechanism for customers to remotely order the goods comprises a Website.

5. The method for distributing purchased goods at retail or wholesale outlet stores of claim 1, wherein the one or more agreements additionally require the retail or wholesale outlet stores to package goods associated with the order confirmation information after the order confirmation information is presented to the retail or wholesale outlet stores.

6. The method for distributing purchased goods at retail or wholesale outlet stores of claim 1, further comprising the step of:
electronically providing a retail or wholesale outlet store associated with the order confirmation information with a packing list associated with the order confirmation information after the order confirmation information is presented to the retail or wholesale outlet store.

7. The method for distributing purchased goods at retail or wholesale outlet stores of claim 1, further comprising the step of:
electronically transferring funds to a retail or wholesale outlet store associated with the order confirmation information after the order confirmation information is presented to the retail or wholesale outlet store.

8. The method for distributing purchased goods at retail or wholesale outlet stores of claim 1, wherein the one or more agreements additionally require the retail or wholesale outlet stores to receive the goods in bulk containers.

9. The method for distributing purchased goods at retail or wholesale outlet stores of claim 8, wherein the one or more agreements additionally require the retail or wholesale outlet stores to return the bulk containers once the bulk containers are empty.

10. The method for distributing purchased goods at retail or wholesale outlet stores of claim 1, wherein the one or more agreements additionally require the retail or wholesale outlet stores to distribute the goods in intimate level protection packaging.

11. A method for distributing purchased goods at retail or wholesale outlet stores, comprising the steps of:
receiving order pick-up information from a customer;
electronically transferring the order pick-up information to a remote order processing facility and electronically receiving a packing list associated with the order pick-up information; and
pulling goods identified in the packing list from bulk containers and providing the goods to the customer without distribution packaging.

12. The method for distributing purchased goods at retail or wholesale outlet stores of claim 11, further comprising the step of:
packaging the goods in intimate level protection packaging before providing the goods to the customer.

13. The method for distributing purchased goods at retail or wholesale outlet stores of claim 12, wherein the intimate level protection packaging includes one or more bags.

14. The method for distributing purchased goods at retail or wholesale outlet stores of claim 12, further comprising the step of:
packaging the goods in one or more structurally reinforced bags.

15. The method for distributing purchased goods at retail or wholesale outlet stores of claim 12, further comprising the step of:
packaging the goods in one or more bags with handles.

16. A processing system for distributing purchased goods at retail or wholesale outlet stores, comprising:
a processor configured to receive an inventory verification request and information pertaining to a geographic location, to identify one or more retail or wholesale outlet stores that are within a particular distance of the geographic location and that have in stock goods identified in the inventory verification request, and to generate a list of the one or more retail or wholesale outlet stores.

17. The processor system for distributing purchased goods at retail or wholesale outlet stores of claim 16, wherein the processor is further configured to generate order confirmation information associated with the goods identified in the inventory verification request and with one of the retail or wholesale outlet stores on the list.

18. The processor system for distributing purchased goods at retail or wholesale outlet stores of claim 17, wherein the order confirmation information is associated with the retail or wholesale outlet store on the list that is closest to the geographic location.

19. The processor system for distributing purchased goods at retail or wholesale outlet stores of claim 17, wherein the order confirmation information is associated with the retail or wholesale outlet store on the list that is selected by a purchaser of the goods.

20. The processor system for distributing purchased goods at retail or wholesale outlet stores of claim 17, wherein the processor is further configured to provide a packing list associated with the goods identified in the inventory verification request in response to an indication that the order confirmation information has been provided to the retail or wholesale outlet store associated with the order confirmation information.

21. The processor system for distributing purchased goods at retail or wholesale outlet stores of claim 17, wherein the processor is further configured to initiate a transfer of funds in response to an indication that the order confirmation information has been provided to the retail or wholesale outlet store associated with the order confirmation information.
